(19) United States
(12) Patent Application Publication
(10) Pub. No.: US 2016/0008763 A1
(43) Pub. Date: Jan. 14, 2016

(54) Improved Spiral Wound Element Construction

(71) Applicant: AQUA MEMBRANES LLC, Albuquerque, NM (US)

(72) Inventors: Kevin Roderick, Albuquerque, NM (US); Rodney Herrington, Albuquerque, NM (US)

(21) Appl. No.: 14/769,601

(22) PCT Filed: Feb. 26, 2014
(86) PCT No.: PCT/US14/18813

§ 371 Date: Aug. 21, 2015

Related U.S. Application Data
(60) Provisional application No. 61/771,041, filed on Feb. 28, 2013.

(51) Int. Cl. B01D 63/10; B32B 7/14

(52) U.S. Cl. CPC B01D 63/103; B32B 7/14; B01D 63/10; B01D 63/106; B32B 2307/726; B01D 2313/14

(57) ABSTRACT

Embodiments of the present invention provide replacement of conventional separate feed spacer mesh with features placed, deposited or integrated on or into either the porous permeate carrier, the inactive side of the membrane sheet, or select portions of the membrane surface. Spiral-wound membrane filtration elements well known in the art consist of a laminated structure comprised of a membrane sheet sealed to or around a porous permeate carrier which creates a path for removal of the fluid passing through the membrane to a central tube, while this laminated structure is wrapped spirally around the central tube and spaced from itself with a porous feed spacer to allow axial flow of the fluid through the element.

### BACKGROUND

1. Field of the Invention

The subject invention relates to a permeable membrane system utilized for the separation of fluid components, specifically spiral-wound membrane permeable membrane elements. The present invention is related to that described in US provisional 61/771,041, filed Feb. 28, 2013, which is incorporated herein by reference.

2. Description of Related Art

Spiral-wound membrane filtration elements well known in the art consist of a laminated structure comprised of a membrane sheet sealed to or around a porous permeate carrier which creates a path for removal of the fluid passing through the membrane to a central tube, while this laminated structure is wrapped spirally around the central tube and spaced from itself with a porous feed spacer to allow axial flow of the fluid through the element. While this feed spacer is necessary to maintain open and uniform axial flow between the laminated structure, it is also a source of flow restriction and pressure drop within the axial flow channel and also presents areas of restriction of flow and contact to the membrane that contribute significantly to membrane fouling via biological growth, scale formation, and particle capture.

Improvements to the design of spiral wound elements have been disclosed by Barger et al and Bradford et al., which replace the feed spacer with islands or protrusions either deposited or embossed directly onto the outside or active surface of the membrane. This configuration is advantageous in that it maintains spacing for axial flow through the element while minimizing obstruction within the flow channel. It also eliminates the porous feed spacer as a separate component, thus simplifying element manufacture.

The following references, each of which is incorporated herein by reference, can facilitate understanding of the invention: U.S. Pat. No. 3,962,096; U.S. Pat. No. 4,476,022; U.S. Pat. No. 4,756,835; U.S. Pat. No. 4,834,881; U.S. Pat. No. 4,855,058; U.S. Pat. No. 4,902,417; U.S. Pat. No. 4,861,487; U.S. Pat. No. 6,632,357.

### DESCRIPTION OF THE INVENTION

Embodiments of the present invention provide replacement of conventional separate feed spacer mesh with features placed, deposited or integrated on or into either the porous permeate carrier, the inactive side of the membrane sheet, or select portions of the membrane surface.

### BRIEF DESCRIPTION OF THE DRAWINGS

FIG. 1A & FIG. 1B are views of spacer features deposited on the permeate carrier within a spiral-wound element.

FIG. 2A & FIG. 2B are views of spacer features deposited on the non-feed surface (inactive or support surface) of the membrane.

FIG. 3 is a view of edge spacing strips placed between a folded membrane leaf.

FIG. 4A is a view of a solid edge spacing strip being cut away from the element during trimming the trimming operation.

FIG. 4B is a view of a porous edge spacing strip being partially cut away from the element during the trimming operation.

FIG. 5A and 5B are views of a solid deposited comb-shaped edge spacer which is partially removed during trimming.

FIG. 6A & FIG. 6B are views of the edge of the membrane sheet being folded for use as an edge spacer which is subsequently removed during trimming.

FIG. 7A & FIG. 7B are views of the edge of the membrane sheet being first perforated or cut, then folded for use as an edge spacer which is subsequently removed during trimming.

FIG. 8A & FIG. 8B are views of an anti-telescoping device applied to the element which adheres to the edges of the spiral-wound element.

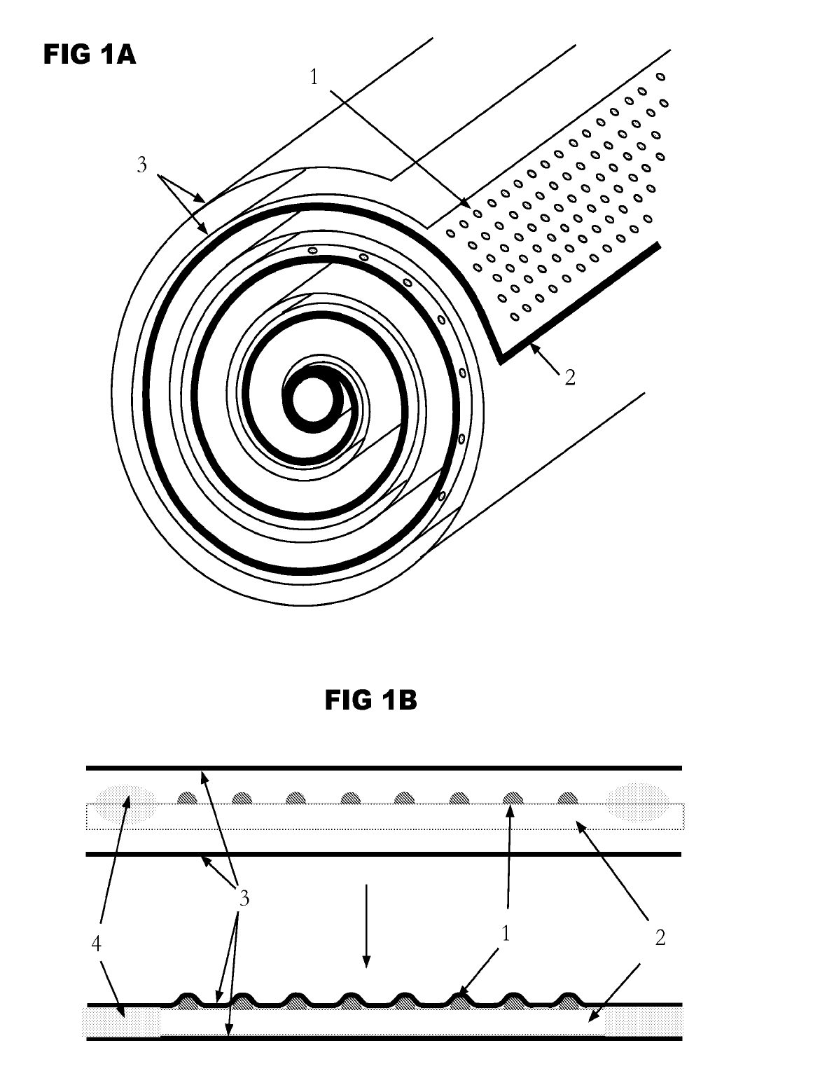

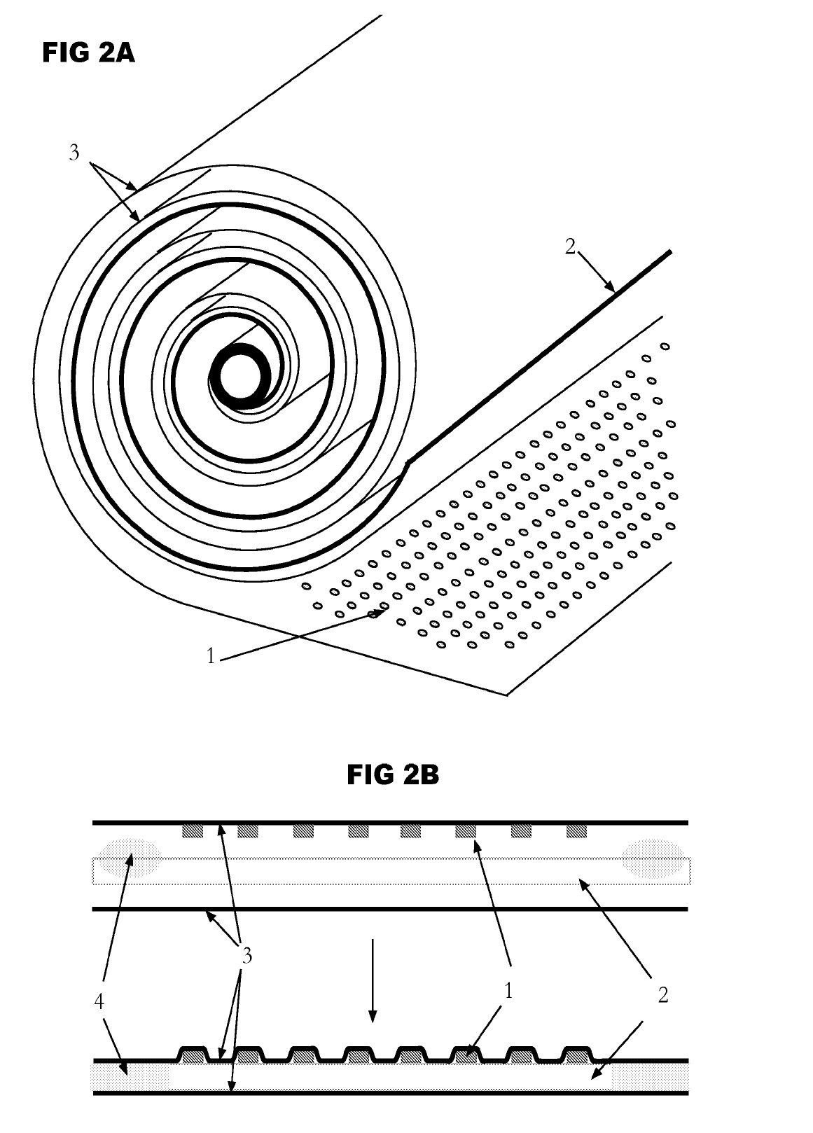

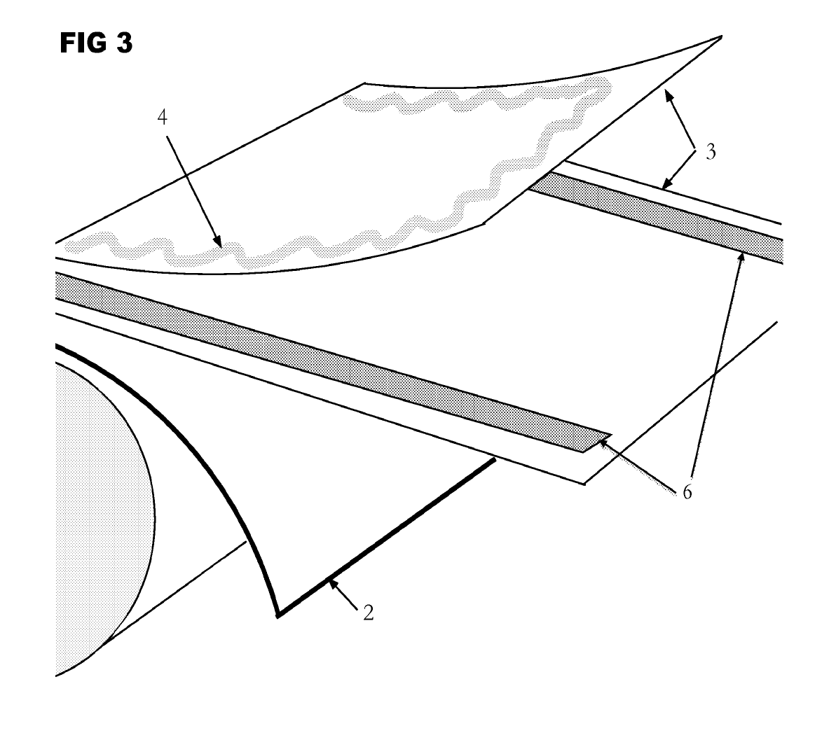

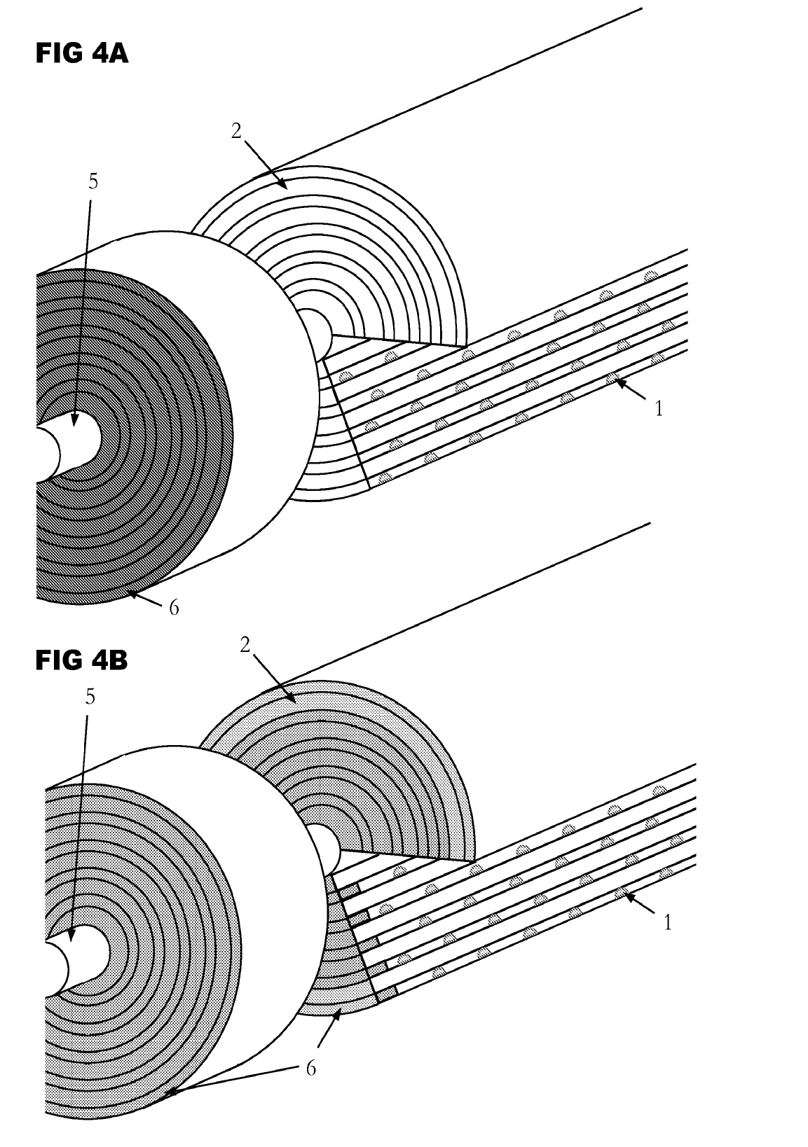

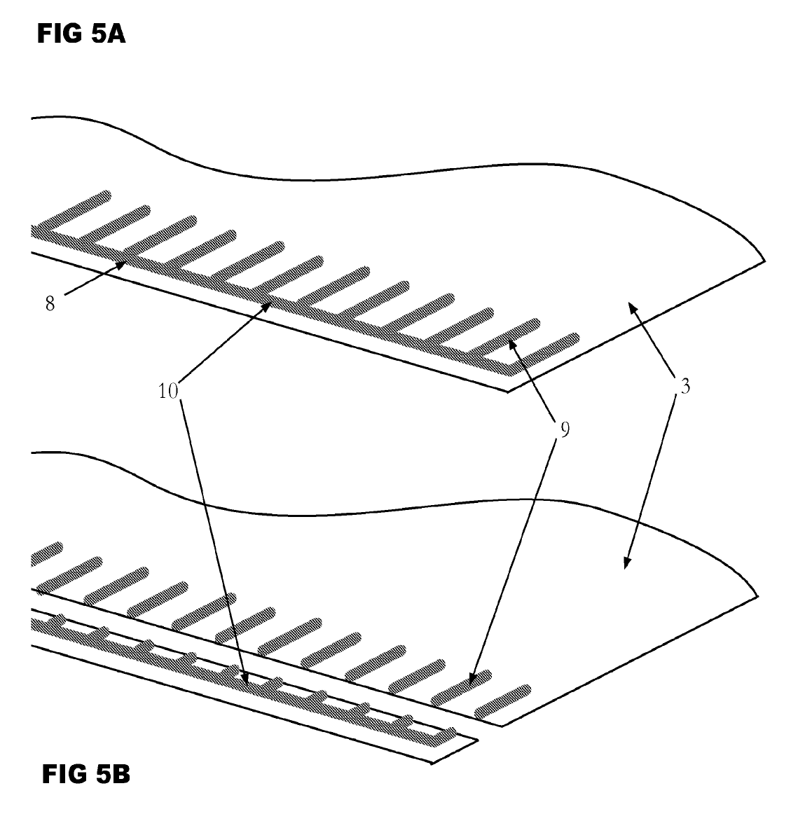

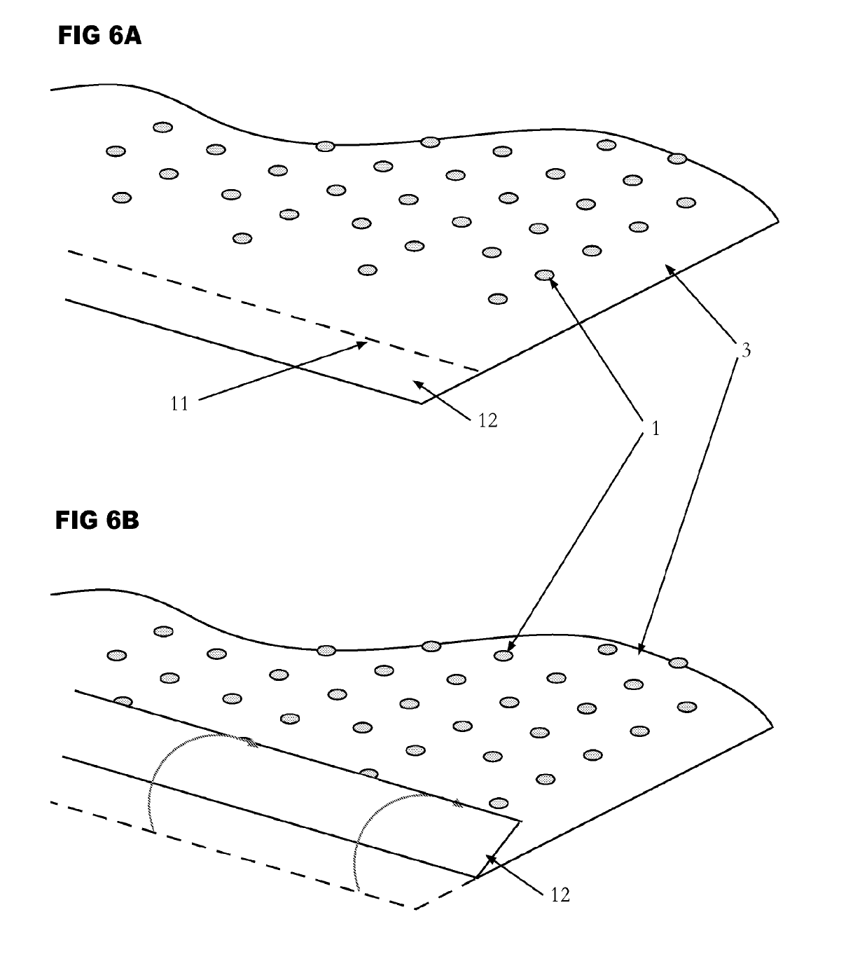

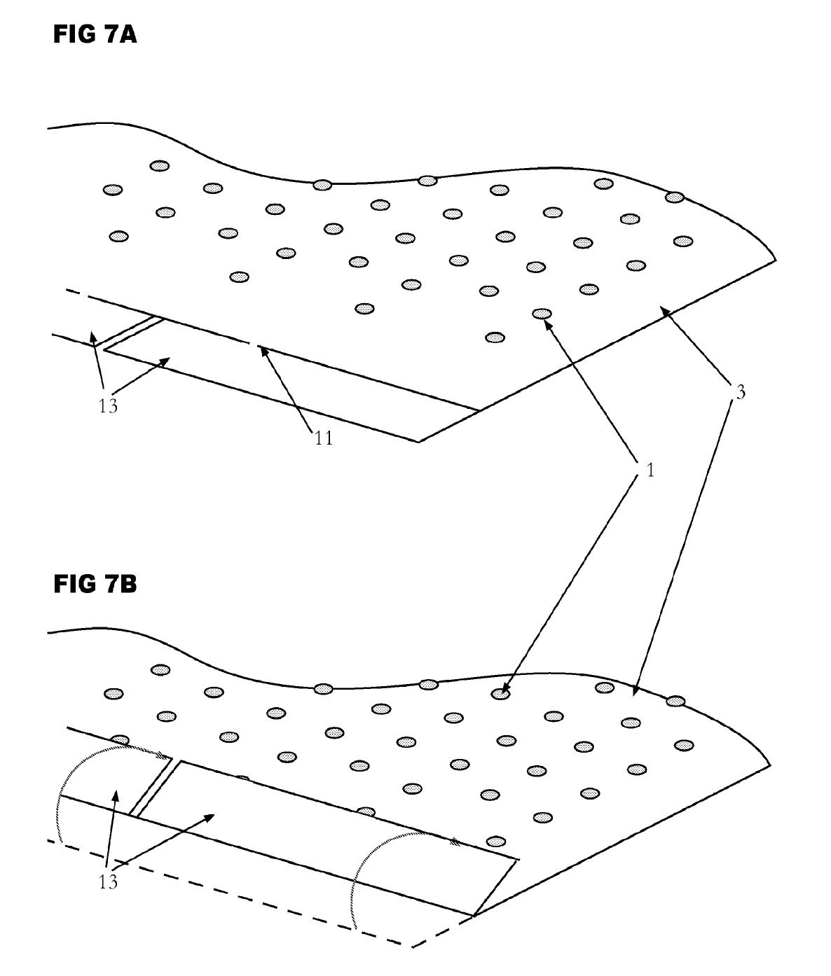

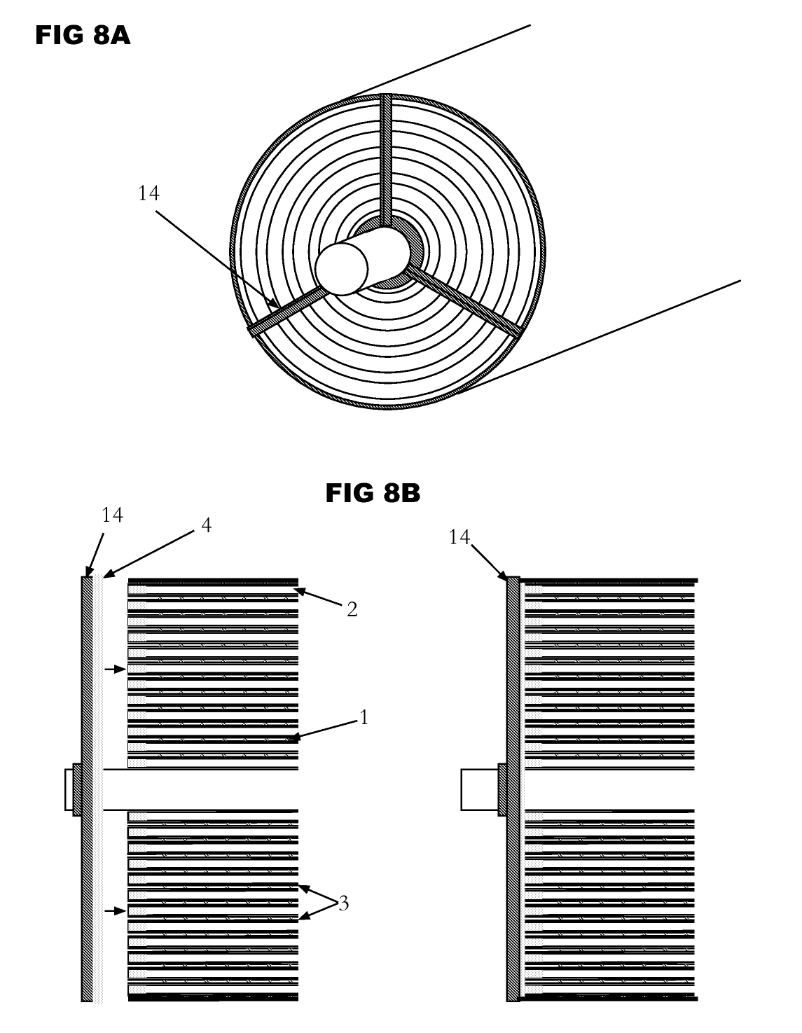

### MODES FOR CARRYING OUT THE INVENTION AND INDUSTRIAL APPLICABILITY

In one embodiment, a single or plurality of spacer features (1) such as posts, islands, straight, curved, or angled line segments or continuous lines, or other complex shapes are deposited onto the surface of the permeate carrier (2) or are introduced into the sheet during the manufacturing process of the porous permeate carrier layer. The height and shape of the features are configured to provide spacing for axial flow in the feed channel as the membrane sheet (3) conforms to the features under applied pressure either during actual operation for elements where high fluid pressures are required to facilitate separation, or under a fixed pressure applied subsequent to assembly and before use for lower pressure systems. Depending on the pressure applied and the membrane composition, such application of pressure may produce either temporary or permanent conformation of the membrane to the features. The features are designed so as to minimize damage to the membrane sheet when it conforms to them. The features may furthermore be designed in such a way as to impart turbulence or direct the flow of the fluid within the feed channel in order to provide desirable characteristics including but not limited to improved mixing of the fluid, increased velocity, or a longer flow path. Design of the features must allow at least one continuous fluid flow channel axially across the element, although the channel or channels may or may not provide a direct path for fluid flow.

The features may be comprised of any number of materials which are compatible with the separated fluid and the permeate carrier including, but not limited to, thermoplastics, reactive polymers, waxes, or resins. Additionally, materials that are compatible with the separated fluid but not compatible with direct deposition to the permeate carrier, including, but not limited to high-temperature thermoplastics, metals, or ceramics, may be pre-formed, cast, or cut to the proper dimensions and adhered to the surface of the permeate carrier with an adhesive that is compatible with the permeate carrier.

The features can be deposited by a variety of techniques. Traditional printing techniques such as offset printing, gravure printing, and screen printing, can be suitable, although there are thickness and geometry limitations with these deposition techniques. Thicker features can be deposited by microdispensing, inkjet printing, fused deposition, or via application using an adhesive that can include roll transfer of sheet or pick-and-place of individual features.

A significant advantage of depositing the spacer features onto the permeate carrier mesh as opposed to the permeable membrane itself is that it allows for deposition techniques and materials use that are incompatible with the membrane itself. Thin film composite membranes are often chemically and physically delicate and their performance can degrade with exposure to heat, light, or various chemicals. Typical permeate carrier films are comprised of polyester fiber which can include epoxy coating and as such are much less susceptible to damage by solvents, heat (up to the melting point of the material), or limited exposure to ultraviolet radiation that can be encountered during UV curing.

In one embodiment, a single or plurality of spacer features such as posts, islands, straight, curved, or angled line segments or continuous lines, or other complex shapes are deposited onto the inside or inactive support surface of the membrane sheet. The height and shape of the features are configured to provide spacing for axial flow in the feed channel as the membrane sheet conforms to the features under applied pressure either during actual operation for elements where high fluid pressures are required to facilitate separation, or under a fixed pressure applied subsequent to assembly and before use for lower pressure systems. Depending on the pressure applied and the membrane composition, such application of pressure can produce either temporary or permanent conformation of the membrane to the features. The features are configured so as to minimize damage to the membrane sheet when it conforms to them. The features can furthermore be configured in such a way as to impart turbulence or direct the flow of the fluid within the feed channel in order to provide desirable characteristics including but not limited to improved mixing of the fluid, increased velocity, or a longer flow path. Configuration of the features must allow at least one continuous fluid flow channel axially across the element, although the channel or channels may or may not provide a direct path for fluid flow.

The features can be comprised of any material which is compatible with the separated fluid and the inside layer of the membrane sheet including, but not limited to, thermoplastics, reactive polymers, waxes, or resins. Additionally, materials that are compatible with the separated fluid but not compatible with direct deposition to the inside surface of the membrane sheet, including, but not limited to high-temperature thermoplastics, metals, or ceramics, can be pre-formed, cast, or cut to the proper dimensions and adhered to the surface of the inside surface of the membrane sheet with an adhesive that is compatible with the inside surface of the membrane sheet.

The features can be deposited by a variety of techniques. Traditional printing techniques such as offset printing, gravure printing, and screen printing can be suitable, although there are thickness and geometry limitations with these deposition techniques. Thicker features may be deposited by microdispensing, inkjet printing, fused deposition, or via application using an adhesive that could include roll transfer of sheet or pick-and-place of individual features.

During element assembly or rolling, typically an adhesive (4) is used to adhere the inner end of the permeate carrier to the center tube (5) and simultaneously bond the permeate carrier to the membrane sheet along its outer edges which acts to prevent entry fluid from either the feed or untreated/reject stream into the permeate carrier excepting that which passes through the membrane (i.e. the adhesive seals the edges of both the membrane sheet and the permeate carrier, forcing any flow of fluid to pass through the membrane). The center tube is commonly cylindrical in shape, but the “tube” can have any shape that is compatible with the assembly and operating characteristics desired. This adhesive is typically applied before the element is rolled, and once the adhesive is cured, excess membrane, permeate carrier, and adhesive is trimmed away in a plane perpendicular to the axis of the cylindrical element at each end at a fixed length. In another embodiment, features which provide spacing between adjacent active leaves of a spiral wound element only along the feed and untreated/reject edges of the element (edge spacing) are placed onto the active side of one or both sides of the element leaves prior to rolling in order to maintain feed spacing during the rolling of the spiral wound element. These edge spacing features can be left in place or either entirely or partially removed during the trimming process subsequent to rolling. These edge spacing features allow compression of the adhesive during element rolling along the edges of the element to ensure that the adhesive completely infiltrates the permeate carrier and bonds to the membrane sheet on both sides of the permeate carrier while maintaining height separation at the edges roughly equivalent to the height of the feed spacer features.

Edge spacing features placed in this manner can be discrete strips (6), or discontinuous segments (e.g., dots, lines, etc.). If discrete strips are used, they must be either be completely removed during the subsequent trimming of the element, or comprised of a porous material to allow fluid flow through them if some portion of the strips is left in place after trimming.

Edge spacing features can be deposited onto the membrane sheet by a variety of techniques. Traditional printing techniques such as offset printing, gravure printing, and screen printing can be suitable, although there are thickness and geometry limitations with these deposition techniques. Thicker features can be deposited by microdispensing, inkjet printing, fused deposition, or via application using an adhesive that could include roll transfer of sheet or pick-and-place of individual features. They can also be applied to the edges of the membrane sheet with an adhesive, or in the form of an adhesive tape.

Discontinuous edge spacing features can be comprised of rigid or semi-rigid materials which will not conform or distort significantly when the membrane sheet is rolled, but will instead allow the flexibility of the membrane sheet to bend to form the spiral shape. More typically however, the edge spacer material will be flexible, due to inherent properties of the material, thinness of the material, or a combination of the two.

The edge spacing features that are deposited directly onto the membrane can be comprised of any number of materials that are compatible with the feed fluid and the membrane sheet including, but not limited to, thermoplastics, reactive polymers, waxes, or resins. Other materials that are compatible with the feed fluid but not compatible with direct deposition to the membrane sheet, including, but not limited to high-temperature thermoplastics, metals, or ceramics, may be pre-formed, cast, or cut to the proper dimensions and adhered to the surface of the permeate carrier with an adhesive that is compatible with the permeate carrier.

Additionally, porous edge spacing (7) features can be comprised of a porous material, such as a woven or non-woven fabric or extruded or woven mesh, in order to allow flow of feed fluid through the edge features.

Edge spacer features in the form of continuous strips can also comprise complex geometries, such as a comb-shaped structure (8) consisting of a spine that is a continuous strip with teeth (9) that extend either perpendicularly or at another angle from the spine (10). The comb-shaped spacer is placed such that the spine is at or near the outermost edges of the membrane sheet prior to rolling, and the teeth are disposed such that they are facing towards each other from either edge. The width of the spine is determined such that when the edges of the membrane element are trimmed subsequent to rolling, the entirety of the spine section of the edge spacer is removed, leaving the teeth to support the edge spacing. The teeth can be straight, or can be curved, angled, or shaped so as to impart direction to the fluid flow that passes between them. The teeth can also be cut off completely during the trimming process.

Edge spacing features that are discrete strips of material can also be placed directly onto the membrane sheet prior to element rolling without being physically adhered to the membrane sheet in any manner. These strips can be continuous strips of solid strips of material which are cut off during trimming subsequent to rolling, porous materials which are wholly or partially cut off during subsequent trimming, or complex geometries of solid or porous materials such as the comb-like structure described previously. The strips can be, but need not be, held in place physically during rolling. Alternately, the strips can be held in place by means such as the same adhesive used to seal the membrane sheets to the permeate carrier. This non dried adhesive can provide sufficient viscosity to keep the strips in position during rolling, yet allow the membrane sheets to slide past one another during rolling, and avoid bunching or binding of the strips in the feed channel. After the membrane elements are rolled and the adhesive is allowed to cure, the end strips can be trimmed off completely, or if porous, partially removed on trimming.

Edge spacing features comprising discrete strips of material can be created from the membrane sheet itself. Because the porosity of the membrane sheet is limited, particularly in the planar dimensions, edge spacing features comprising continuous strips of membrane sheet must be completely removed during the trimming process to allow feed and untreated/reject water to flow through the element. Such features can also be formed with a comb-shaped structure which would only need to be partially cut away, leaving the teeth of the comb-shaped structure to maintain edge spacing after the spine has been removed. These features can be created by cutting strips of the membrane sheet and placing them along the edges inside a folded leaf of membrane sheet, or they can be created as part of the membrane sheet leaf that is used to create the element by starting with a membrane sheet that is wider than needed and using a partial or perforated slit (11) at a fixed spacing from the edge of the sheet and then folding over the outermost edge (12) which is partially attached to the membrane sheet. In the latter configuration the edge spacing feature remains attached to the membrane sheet such that its position is maintained during assembly. The connective segments that maintain attachment of this membrane based edge spacing feature can be left in place or can be cut away during element rolling to allow movement of the feature relative to the membrane sheet during rolling. Alternately, the edge spacer strip can itself be discontinuous, with cuts or cutouts being employed periodically in order to allow each strip segment (13) some degree of movement relative to the leaves of the membrane sheet during the rolling of the element. If the connective segments are cut away to allow movement of the spacing feature strip relative to the membrane sheet during rolling, the spacing feature strip can be held in place temporarily by uncured adhesive that can have sufficient viscosity to hold the strip in place during rolling, but allow the strip to slide relative to the membrane sheet during the rolling process, and thereby avoid bunching or binding of the spacing feature strip.

For physical edge spacers which are deposited on the edge of the membrane sheet which will either remain in place after trimming or be completely trimmed away, it can be beneficial to construct these edge spacers of short segments with an unprinted segment between each of the short segments. For edge segments that will not be completely trimmed away, the unprinted segments will form the space that allows feed flow in and the untreated/reject stream out of the element. To avoid the short physical edge segments from fitting between the gaps in adjacent segments one layer closer or farther from the tube, it is beneficial to make the short edge segments wider than the spaces between the edge segments. This technique allows complete compression of the membrane sheets at the edge of the element during rolling (to allow the glue to fully seal) and also avoids the membrane sheets from bunching or binding during rolling.

Due to the nature of the design, embossed elements can offer little resistance to telescoping. The spiral wrap on an embossed element can also be subject to radial movement relative to the center tube on the element. Conventional anti-telescoping devises assume that the spiral element will not be subject to radial movement of the spiral membrane sheets. As such, there is no intent with conventional anti-telescoping devices to try and hold the spiral membrane sheets in position. Some embodiments of the current invention provide anti-telescoping (14) devices that have radial arms from the center tube that are can be glued or otherwise attached to the ends of the spiral wraps. This can ensure that the feed and reject ends of the spiral element will be held in place to facilitate uniform flow distribution into and out of the membrane element.

In one example, a thin film composite membrane sheet 12″ wide is cut to a length of 80″ and folded in half to make a membrane leaf to be incorporated into a spiral wound element. Feed spacer elements comprising roughly cylindrical posts with a diameter of 0.025″ and a height of 0.008″ are deposited via screen printing using a 2-part epoxy in a triangular lattice pattern spaced 0.25″ center to center onto half of the membrane leaf on the inactive/support side. The elements do not extend over the entire surface but leave a 2.25″ margin along two opposite edges of the membrane sheet which correspond to the area that the glue line in the assembled element will occupy. After the feed spacer elements are deposited and cured, additional edge spacing features comprising an parallel array of raised lines 2″ long, 0.025″ wide and 0.008″ tall spaced 0.125″ apart are deposited via screen printing using 2-part epoxy on the active side of the half of the membrane leaf along the two opposite edges where the inactive/support side was not printed. After the edge spacers cured, the folded leaf is placed onto an 87″×12″ length of permeate carrier which is attached along one of the 12″ edges to a 12″ long center tube with a diameter of 0.67″ with the fold spaced ˜3″ from the attachment to the center tube. Adhesive is applied in a continuous bead from a point starting at the attachment of the permeate carrier to the center tube ˜1″ from the edge of the membrane leaf and continuing along one long edge, around the end opposite the fold, and back along the other long edge at the 1″ distance from the edge. Subsequent to adhesive deposition, the leaf is rolled around the center tube to create a spiral wound element with an outer diameter of ˜1.8″. After the adhesive has dried, the ends of the element are trimmed off 1″ in from each edge of the center tube, leaving an element structure that is ˜10″ long x 1.8″ diameter on a 12″ long center tube. On each edge of the element, 1″ of the edge spacing feature remains which allows entry of the feed stream and egress of the reject stream. When the element is pressurized, the pressure forces the membrane to conform to the features printed on the inactive side of the leaf, creating a continuous flow channel from the inlet to the reject end of the element regularly punctuated by the feed spacer features.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those skilled in the art.

1. An apparatus for use in a permeable membrane system, comprising a laminated composition comprising:
(a) a substantially planar permeate carrier;
(b) a substantially planar membrane having a first surface suitable for contact with a fluid being processed, and a second surface opposite the first surface;
(c) one or more spacing features;
wherein the membrane is disposed such that the second surface of the membrane is adjacent the permeate carrier, with the spacing features disposed therebetween.

2. A laminated composition as in claim 1, wherein the spacing features are deposited on the second surface of the membrane.

3. A laminated composition as in claim 1, wherein the spacing features are deposited on the permeate carrier.

4. A membrane for incorporation in a laminated composition for use in a permeable membrane system, comprising a substantially planar element bounded by four edges, having spacing elements disposed on the planar element adjacent two opposing edges, wherein the spacing elements are configured to maintain feed spacing and allow glue compaction during assembly into a laminated composition.

5. A membrane as in claim 4, wherein the spacing elements comprise solid strips extending along the planar element substantially parallel to the corresponding edges.

6. A membrane as in claim 4, wherein the spacing elements comprise a plurality of solid strips extending along the planar element substantially parallel to the corresponding edges, with spaces between adjacent strips.

7. A membrane as in claim 4, wherein the spacing elements comprise comb-shaped elements, each having a continuous back disposed proximal the corresponding edge and a plurality of teeth with spaces between and extending from the continuous back away from the edge.

8. A membrane as in claim 4, wherein the spacing elements comprise a portion of the planar element folded along a fold line substantially parallel to the edge.

9. A membrane as in claim 8, wherein the portion of the planar element folded has one or more slots extending from the edge to the fold line, such that when folded the spacing element is not continuous along the edge.

10. (canceled) cm 11. (canceled)

12. An apparatus as in claim 1, further comprising a permeable membrane system including the laminated composition.

13. An apparatus as in claim 12, wherein the spacing features are deposited on the second surface of the membrane.

14. A method of producing an apparatus suitable for use in a permeable membrane system, comprising:
supplying a substantially planar permeate carrier;
supplying a substantially planar membrane, having a first surface suitable for contact with a fluid being processed, and a second surface opposite the first surface;
placing the second surface of the membrane in contact with the permeate carrier with one or more spacing features disposed therebetween.

15. A method as in claim 14, comprising disposing a plurality of spacing features on the permeate carrier prior to placing the second surface of the membrane in contact with the permeate carrier.

16. A method as in claim 14, comprising disposing a plurality of spacing features on the second surface of the membrane prior to placing the second surface of the membrane in contact with the permeate carrier.

17. A method of making a permeable membrane system, comprising:
supplying one or more membrane leaves, each having an active membrane surface, and disposing the leaves such that active membrane surfaces face active membrane surfaces;
disposing spacing elements along two opposing edges of the membrane leaves, between the active membrane surfaces;
disposing the membrane leaves with spacer features onto one or more permeate carrier sheets which are affixed to a center tube;
depositing adhesive on edges of each leaf on the inactive surface;
rolling the membrane leaves, permeate carrier, spacer features, and adhesive around the center tube to form a spiral wound element;
removing a portion of the assembly corresponding to the portion of the membranes occupied by the spacing elements.

18. A method as in claim 17, wherein the portion of the assembly removed corresponds to the entirety of the portion of the membrane occupied by the spacing elements.

19. A method as in claim 17, comprising mounting an anti-telescoping device with one or more ends of the assembly, attached to the edges of the membranes to discourage both telescoping motion of the membranes and radial movement of the membranes.

20. A method as in claim 14, further comprising:
supplying a second substantially planar membrane, having a first surface suitable for contact with a fluid being processed, and a second surface opposite the first surface;
disposing spacing elements along the edges of at least one of the membranes on the first surface thereof;
depositing adhesive around the edges of the each membrane on the second surface thereof to form a pre-roll composition;
rolling pre-roll composition around a center tube to form a spiral wound element;
mounting an anti-telescoping device with one or more ends of the assembly, attached to the edges of the membranes to discourage both telescoping motion of the membranes and radial movement of the membranes.

21. A method as in claim 20, wherein supplying a second substantially planar membrane comprises folding the first substantially planar membrane such that the first surface of the membrane on one side of the fold faces the first surface of the membrane on the other side of the fold.

22. A method of separating a fluid using a membrane system as in claim 12, where the membrane system is mounted within a pressure vessel having a fluid inlet, a reject outlet, and a permeate outlet, the method comprising;
introducing fluid under pressure to the fluid inlet;
using the membrane system to separate the fluid;
collecting a separated fluid through the permeate outlet and;
collecting a concentrated reject stream through the reject outlet.
